(19) United States
(12) Patent Application Publication
(10) Pub. No.: US 2007/0130831 A1
(43) Pub. Date: Jun. 14, 2007

(54) System and method for co-production of hydrogen and electrical energy

(75) Inventors: Ravikumar Sathya Vipperla, Irvine, CA (US); Parag Prakash Kulkarni, Tustin, CA (US); Vladimir Zamansky, Oceanside, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/297,774

(22) Filed: Dec. 8, 2005

(51) Int. Cl. C10J 3/46; F02G 3/00

(52) U.S. Cl. 48/197 R; 60/39.12

(57) ABSTRACT

A system for the co-production of hydrogen and electrical energy includes a reformer comprising at least one mixed reforming zone configured to receive a fuel stream and steam, at least one steam reforming zone and a plurality of oxidant inlets to introduce an oxidant into the reformer. The mixed reforming zone is followed by the steam reforming zone to produce a first reformate stream comprising hydrogen. The system further includes a shift reactor configured to receive the first reformate stream and generate a second reformate stream and a carbon dioxide separation unit configured to receive the second reformate stream and separate carbon dioxide from the second reformate stream to generate a carbon dioxide rich stream and a hydrogen rich stream. The system also includes a power generation device configured to receive the hydrogen rich stream to generate electrical energy.

### BACKGROUND OF THE INVENTION

This invention relates to the co-production of hydrogen and electrical energy from a variety of hydrocarbon fuels. More particularly this invention relates to the co-production of hydrogen and electrical energy from a variety of hydrocarbon fuels with carbon dioxide (CO₂) separation.

Currently, the most cost effective method of producing hydrogen is centralized steam reforming of fuels such as natural gas. Rising energy prices and concern for the environment are prompting increased attention to hydrogen as an energy source. Hydrogen has been proposed as a clean fuel for the future with many applications including for use with vehicles and with stationary power. Thermal management, scale up of the reactors and heat integrations are some of the challenges in the reforming processes, such as catalytic partial oxidation (CPO), steam reforming and autothermal reforming (ATR). Reforming processes are energy intensive and the hydrogen-rich synthesis gas generated by the reforming processes also contain carbon dioxide. When this synthesis gas is used as a fuel in a power generation system such as a turbine, CO₂ is carried with the exhaust gas generated from the turbine.

Unless CO₂ is removed from an exhaust gas from a power plant (such as a turbine exhaust), it is released into the atmosphere. Unchecked release of CO₂ into the atmosphere is considered a potential cause of global warming and an unsound environmental practice. Removal or recovery of the carbon dioxide (CO₂) from the exhaust of a gas turbine, however, is generally not economical due to low CO₂ content and low (ambient) pressure of the exhaust.

Therefore there is a need for a co-production system for hydrogen and electrical energy, which system can burn a clean fuel like hydrogen, and can also economically separate CO₂.

### BRIEF DESCRIPTION OF THE INVENTION

A system for the co-production of hydrogen and electrical energy includes a reformer comprising at least one mixed reforming zone configured to receive a fuel stream and steam, at least one steam reforming zone and a plurality of oxidant inlets to introduce an oxidant into the reformer. The mixed reforming zone is followed by the steam reforming zone to produce a first reformate stream comprising hydrogen. The system further includes a shift reactor configured to receive the first reformate stream and generate a second reformate stream and a carbon dioxide separation unit configured to receive the second reformate stream and separate carbon dioxide from the second reformate stream to generate a carbon dioxide rich stream and a hydrogen rich stream. The system also includes a power generation device configured to receive the hydrogen rich stream to generate electrical energy.

A system for co-production of hydrogen and electrical energy includes a reformer comprising at least one mixed reforming zone configured to receive a fuel stream and steam and a plurality of oxidant inlets to introduce an oxidant into the reformer to generate a first reformate stream comprising hydrogen. The system further includes a shift reactor configured to receive the first reformate stream and generate a second reformate stream and a carbon dioxide separation unit configured to receive the second reformate and separate carbon dioxide from the second reformate to generate a carbon dioxide rich stream and a hydrogen rich stream. The system also includes a gas turbine configured to receive the hydrogen rich stream to generate power and an expanded hot gas stream, a heat recovery system configured to receive the expanded hot gas stream and generate steam and a hot exhaust gas. A steam turbine is configured to receive a portion of the steam to generate power.

A method for co-production of electrical energy and hydrogen comprising reforming a fuel in a reformer comprising at least one mixed reforming zone configured to receive the fuel stream and steam, at least one steam reforming zone, and introducing an oxidant through a plurality of oxidant inlets into the reformer to produce a first reformate stream. The method further includes introducing the first reformate stream in a shift reactor and generating a second reformate stream comprising hydrogen and carbon dioxide. The method also includes separating carbon dioxide from the second reformate stream in a carbon dioxide separation unit and generating a carbon dioxide rich stream and a hydrogen rich stream and introducing the hydrogen rich stream into a gas turbine and generating electrical energy and an expanded hot gas stream. The method further includes introducing the hot gas stream into a heat recovery system and generating steam and introducing a portion of the steam from the heat recovery system into a steam turbine and generating electrical energy.

### DESCRIPTION OF TIHE DRAWINGS

These and other features, aspects, and advantages of the present invention will become better understood when the following detailed description is read with reference to the accompanying drawings in which like characters represent like parts throughout the drawings, wherein;

FIG. 1 illustrates an exemplary co-production system for hydrogen and electrical energy;

FIG. 2 illustrates another exemplary co-production system for hydrogen and electrical energy;

FIG. 3 illustrates yet another exemplary co-production system for hydrogen and electrical energy with layered catalyst;

FIG. 4 illustrates an exemplary layered catalyst;

FIG. 5 illustrates another exemplary co-production system for hydrogen and electrical energy with a catalytic partial oxidation reformer; and

FIG. 6 illustrates yet another exemplary co-production system for hydrogen and electrical energy with a cooling zone within the reformer.

### DETAILED DESCRIPTION OF THE INVENTION

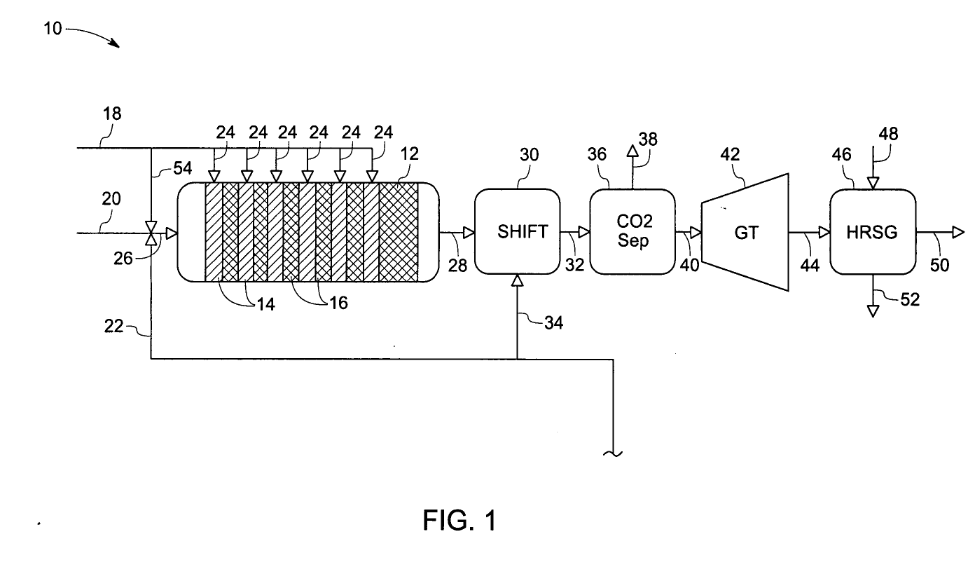

FIG. 1 illustrates a system 10 for the co-production of hydrogen and electrical energy including a reformer 12. The reformer 12 includes at least one mixed reforming zone 14 configured to receive a fuel stream 20 and steam 22. The reformer 12 further includes at least one steam reforming zone 16 and a plurality of oxidant inlets 24 to introduce an oxidant into the reformer 12. In one embodiment, a portion of the oxidant is mixed with the fuel stream 20 and steam 22. As shown in FIG. 1, in some embodiments, the reformer 12 includes a plurality of mixed reforming zones 14 and steam reforming zones 16. Each of the mixed reforming zones 14 is followed by a steam reforming zone 16 to produce a first reformate stream 28 comprising hydrogen. The mixed reforming zone 14 comprises a catalyst for promoting catalytic partial oxidation reaction. In one embodiment, the mixed reforming zone 14 promotes both catalytic partial oxidation (CPO) and steam reforming reactions. The mixed reforming zone may also include an auto-thermal reforming (ATR) zone. Each steam reforming zone 16 advantageously utilize the heat generated by the exothermic partial oxidation reactions in the adjacent mixed reforming zones 14. The system further includes a shift reactor 30 configured to receive the first reformate stream 28 and generate a second reformate stream 32 and a carbon dioxide separation unit 36 configured to receive the second reformate stream 32 and separate carbon dioxide from the second reformate stream 32 to generate a carbon dioxide rich stream 38 and a hydrogen rich stream 40. The system further includes a power generation device configured to receive the hydrogen rich stream 40 and generate electrical energy. The power generation device may be one of a gas turbine, a fuel cell or a reciprocating engine or a combination thereof. In one embodiment, as shown in FIG. 1, the power generation device is a gas turbine 42. The gas turbine 42 is configured to receive the hydrogen rich stream 40 to generate electrical energy and an expanded hot gas stream 44. The exemplary system as shown in FIG. 1 includes a heat recovery system 46 configured to receive the expanded hot gas 44 and generate steam and a cooled exhaust gas 50. In some embodiments, the heat recovery system 46 is a heat recovery steam generator (herein after HRSG).

The exemplary system 10 may further include a shift reactor 30. The second reformate stream 28 from the reformer 12 is sent to the shift reactor 30 and in the presence of a shift catalyst the carbon monoxide in the first reformate stream 28 is converted to carbon dioxide and a second reformate stream 32 rich in hydrogen is generated. Shift catalyst may include a high temperature shift catalyst (HTS) or a low temperature shift catalyst (LTS) or a combination of HTS and LTS catalysts. The second reformate gas stream 32 rich in hydrogen is further treated in a carbon dioxide separation unit 36 to generate the hydrogen rich stream 40 and the carbon dioxide rich stream 38.

In operation, the exemplary system 10 for hydrogen production as illustrated in FIG. 1 uses the concept of utilizing the heat generated from the catalytic partial oxidation to enhance the steam reforming reaction which is endothermic and needs external heat input. Each of the mixed reforming zones 14 contain a CPO catalyst and each of the steam reforming zones 16 contains a steam reforming catalyst.

The primary reactions that occur over the CPO catalyst are indicated in reactions 1-3 below:
CH₄+1/2O₂═CO+2H₂ (1)
CH₄+3/2O₂═CO+2H₂O (2)
CH₄+2O₂═CO₂+2H₂O (3)

Returning back to FIG. 1, a portion of oxidant 54 (optional), the fuel 20 and a portion of steam 22 are mixed and the mixed stream 26 is passed over the CPO catalyst in the mixed reforming zone 14. In one embodiment only the fuel 20 and a portion of steam 22 are mixed and the mixed stream 26 is introduced into the mixed reforming zone 14. The CPO reaction takes place until the oxygen content in the mixed stream 26 is substantially depleted and the temperature is raised through the exothermic CPO reactions (1-3). Subsequently the steam reforming reaction starts within the steam reforming zone 16 utilizing the heat generated by the exothermic CPO reactions. The mixed reforming zone 14 is configured to operate at about 700° C. to about 1400° C. to achieve high fuel conversion and to maximize H₂ yield. As shown in FIG. 1, in some embodiments a plurality of mixed reforming zones 14 and steam reforming zones 16 are provided within the reformer 12, wherein a mixed reforming zone 14 is followed by a steam reforming zone 16. Each of the oxidant inlets 24 supplies a portion of the oxidant to each of the mixed reforming zone 14. In each of the mixed reforming zones 14, heat is generated through the exothermic partial oxidation reactions 1-3. The reactions continue till the portion of the oxidant introduced through oxidant inlet 24 is depleted and therefore the exothermic reactions are controlled to keep the temperature in the mixed reforming zones 14 under the tolerance temperature limit of the CPO catalyst. The heat generated through the partial oxidation reactions 1-3 is advantageously used to supply the heat required for the endothermic steam reforming reactions in the adjacent steam reforming zone 16. This exchange of heat between the mixed reforming zones 14 and the steam reforming zones 16 along with the staged oxidant injections result in an efficient thermal management of the reformer 12.

Conventional steam reforming process is energy intensive and significant heat is needed in the overall reforming process. The main constituent of a fuel, such as natural gas is methane (CH₄) that reacts with steam in a two-step reaction to produce hydrogen. In accordance with the present technique as shown in FIG. 1, natural gas is converted to hydrogen following the reactions (4) and (5) as mentioned below.
CH₄+H₂O [symbol] CO+3H₂ (4)
CO+H₂O [symbol] CO₂+H₂ (5)
The first reaction (4) as described above typically takes place in the steam-reforming zone 16, wherein the fuel such as methane reacts with steam to produce carbon monoxide and hydrogen. In one embodiment, the first reformate gas stream 28 generated from the reformer 12 comprises carbon monoxide (CO), carbon dioxide (CO₂), hydrogen (H₂), unutilized fuel and water. The second reaction (5) is the shift reaction, wherein carbon monoxide is converted to carbon dioxide and this reaction mainly takes place in the shift reactor 30.

In operation, the reformer 12 promotes exothermic reactions due to partial oxidation (catalytic or non-catalytic) in the mixed reforming zone(s) 14 and endothermic reactions due to steam reforming in the steam reforming zone(s) 16. Typically, the partial oxidation reactions are very fast and the steam reforming reactions are slow. In case the entire amount of oxidant is pre-mixed with the fuel 20, a sudden temperature rise is expected in the first part of the reformer where the premixed stream is introduced due to the fast partial oxidation reactions. This sudden temperature rise in the beginning of the reformer generates hot spots in the reformer and reduces the life of the reformer. Therefore the temperature in the partial oxidation reforming zone needs to be moderated in a reformer. The moderation may be achieved using several methods.

As shown in FIG. 1 the moderation of the temperature in a reformer is achieved by layering of the CPO catalyst and the steam reforming catalyst as described above and also by injecting the oxidant through a plurality of the inlets 24. Staging the introduction of the oxidant into the mixed reforming zones 14 along the length of the reformer 12 makes the upstream portion of the reformer 12 fuel rich, which fuel rich condition moderates the temperature rise within the reformer 12. Furthermore due to the staging of both the catalysts and the oxidant, in each of the mixed reforming zone, the CPO catalyst is exposed to a pre-determined amount of oxidant and hence the CPO reactions may be controlled to achieve a uniform and controlled temperature rise in the mixed reforming zone 16. The staging of CPO and the steam reforming catalysts in parallel or series within the reformer, as described above, increase the surface contact of the CPO and the steam reforming catalysts and enhances the heat exchange between the mixed reforming zones 14 and the steam reforming zones 16.

The fuel used in the systems for hydrogen production disclosed herein may comprise any suitable gas or liquid, such as for example, natural gas, a stream comprising carbon monoxide or hydrogen, naphtha, butane, propane, diesel, kerosene, ethanol, methanol, aviation fuel, a coal derived fuel, a bio-fuel, an oxygenated hydrocarbon feedstock, and mixtures thereof. In some embodiments, the fuel may preferably comprise natural gas (NG). The oxidant used in the disclosed systems may comprise any suitable gas containing oxygen, such as for example, air, oxygen rich air, oxygen depleted air, or pure oxygen.

The second reformate gas stream 32 rich in hydrogen is further treated in a carbon dioxide separation unit 36 to generate the hydrogen rich stream 40 and the carbon dioxide rich stream 38. The carbon dioxide separator unit 36 may apply various techniques known in the art, including but not limited to pressure swing adsorption, chemical absorption and membrane separation, to separate the carbon dioxide from the second reformate gas stream 32. In some embodiments, the second reformate stream 32 may be cooled in a heat exchanger (not shown) prior to being introduced into the carbon dioxide separator 36.

As mentioned above, pressure swing adsorption (PSA) can be used for separation of carbon dioxide from a mixture of gases. In PSA techniques, at a high partial pressure, solid molecular sieves adsorb carbon dioxide more strongly than other gases. As a result, at elevated pressures, carbon dioxide is removed from the mixture of gases as this mixture is passed through an adsorption bed. Regeneration of the bed is accomplished by depressurization and purging. Typically for critical operations, a plurality of adsorption vessels are used for continuous separation of carbon dioxide, wherein one adsorption bed is utilized for carbon dioxide separation while the others are regenerated.

Another technique for separation of carbon dioxide from a gas stream is chemical absorption using oxides, such as, calcium oxide (CaO) and magnesium oxide (MgO) or a combination thereof. In one embodiment, at elevated pressure and temperature, CO₂ is absorbed by CaO forming calcium carbonate (CaCO₃), thereby removing CO₂ from the gas mixture. The sorbent CaO is regenerated by calcinations of CaCO₃, which can again reform CaCO₃ to CaO.

Membrane separation technology may also be used for separation of carbon dioxide from a gas stream. Membrane processes are generally more energy efficient and easier to operate than absorption processes. The membranes used for high temperature carbon dioxide separation include zeolite and ceramic membranes, which are selective to CO₂. However, the separation efficiency of membrane technologies is low, and complete separation of carbon dioxide may not be achieved through membrane separation.

Yet another technique used for separation of CO₂ from the second reformate stream 32 may include, but is not limited to, chemical absorption of CO₂ using amines. The second reformate stream 32 is cooled to a suitable temperature to use chemical absorption of carbon dioxide using amines. This technique is based on alkanol amines solvents that have the ability to absorb carbon dioxide at relatively low temperatures and are easily regenerated by raising the temperature of the rich solvents. A carbon dioxide rich stream 38 is obtained after regeneration of the rich solvent. The solvents used in this technique may include, for example, triethanolamine, monoethanolamine, diethanolamine, diisopropanolamine, diglycolamine, and methyldiethanolamine. Another technique for separating CO₂ may be physical absorption. It may be noted that all or a combination of any of the techniques described above for CO₂ separation can be used to separate CO₂ advantageously

In this exemplary embodiment as illustrated in FIG. 1, substantial carbon dioxide isolation is achieved. The hydrogen rich stream 40 is sent to the turbine 42 as a fuel and since the hydrogen rich stream 40 is substantially free of CO₂, the exhaust gas 44 generated in the turbine 42 is also substantially free of CO₂. Therefore the cooled exhaust 50 vented to the atmosphere typically does not release significant quantities of CO₂. In some embodiments, the turbine 42 typically includes a compressor and a rotor (not shown), by which turbine 42 drives a compressor (not shown) and generates electricity.

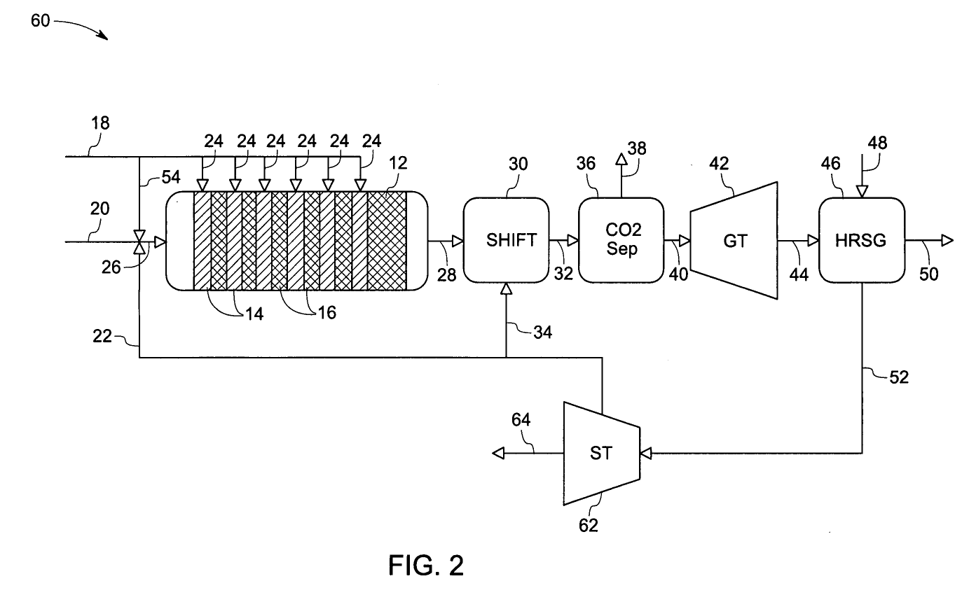

FIG. 2 illustrates yet another exemplary system 60, wherein the high pressure steam 52 generated in the HRSG 46 is sent to a steam turbine 62 to generate additional electrical energy and an expanded steam 66. A portion of the partially expanded steam 22 can be used to reform the fuel 20 in the reformer 12. In one embodiment, another portion of the partially expanded steam 66 is used in the shift reactor 30 to enhance the generation of carbon dioxide.

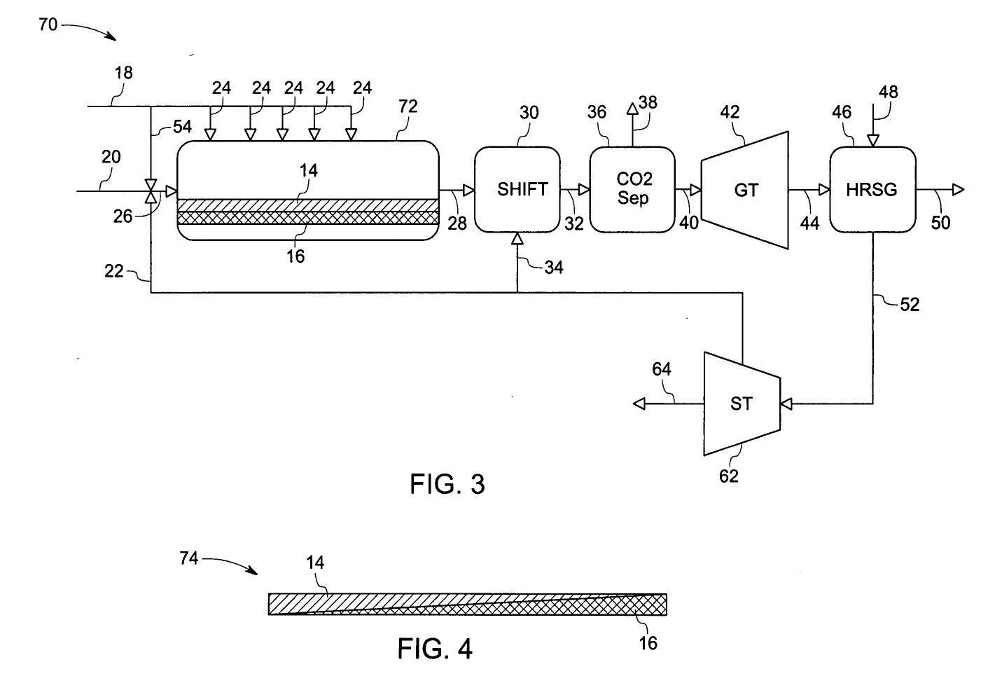

The exemplary embodiments as illustrated in FIGS. 1-2 include the reformer 12, wherein the CPO catalyst in a plurality of the mixed reforming zones 14 and the steam reforming catalysts in a plurality of steam reforming zones 16 are in an arrangement that is perpendicular to the flow of the fuel 20. FIG. 3 illustrates yet another exemplary system 70, wherein the CPO and the steam reforming catalyst are arranged in layers perpendicular to the flow of oxidant, which oxidant is introduced along the length of the catalyst through the plurality of the openings 24. As shown in FIG. 3, the mixture of the fuel and oxidant first gets exposed to the entire surface area of the CPO catalyst in the mixed reforming zone 14. Subsequently the gaseous products generated in the reforming reactions (1-5) in the mixed reforming zone are exposed to the steam reforming catalyst in the steam reforming zone 16. Furthermore close proximity of the entire mass of the CPO and the steam reforming catalysts results in effective heat transfer from the mixed reforming zone 14 to the steam reforming zone 16. In the exemplary embodiment as shown in FIG. 3, the staging of the oxidant along the length of the reformer 12 is optional. However in one embodiment, the staging of the oxidant along the length of the reformer 12 helps to avoid subsequent hot spots in the mixed reforming zone 16.

FIG. 4 illustrates another exemplary arrangement of the CPO catalyst in the mixed reforming zone 14 and steam reforming catalyst in the steam reforming zone 16, wherein the catalyst bed is tapered from one end 76 to the other end 78 along the length of the reformer. The advantage of such an arrangement is that, the contact surface area 76 between the mixed reforming zone 14 and the steam reforming zone 16 is higher than the surface area as shown in FIG. 3. This increased surface area facilitates the heat transfer between the two zones. Furthermore the extent of CPO and steam reforming reactions may be controlled by such a layered arrangement of the CPO and steam reforming catalysts.

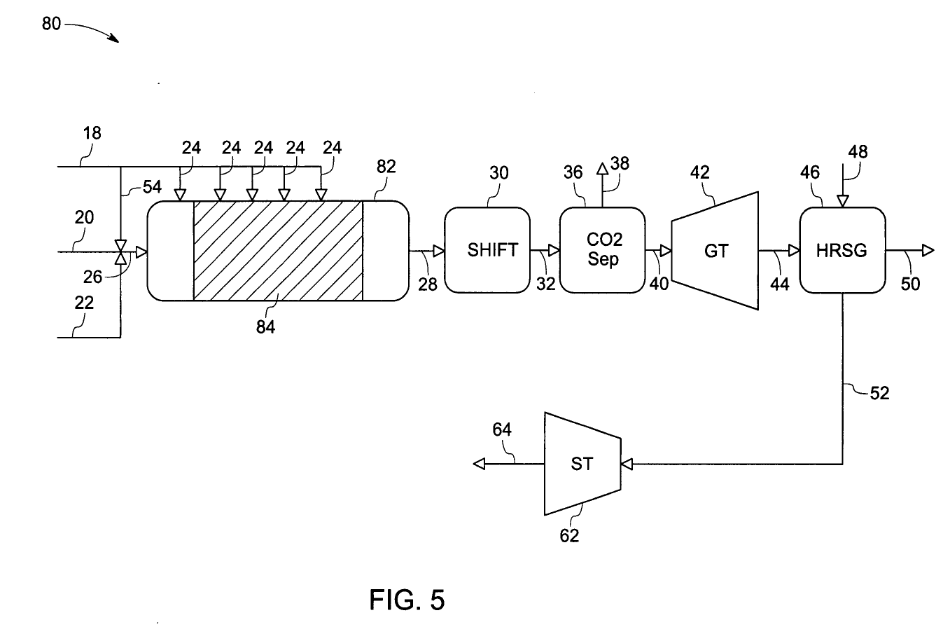

FIG. 5 illustrates yet another exemplary system 80 including a mixed reforming zone 84 in a CPO Reformer 82. The mixed reforming zone 84 includes a CPO catalyst. As discussed earlier, the mixed reforming zone 84 promotes both CPO and steam reforming reactions. As shown in FIGS. 1-3 the oxidant is introduced through multiple inlets 24. Due to the multiple injections of the oxidant along the length of the catalyst, the formation of hot spots in the CPO catalyst may be avoided.

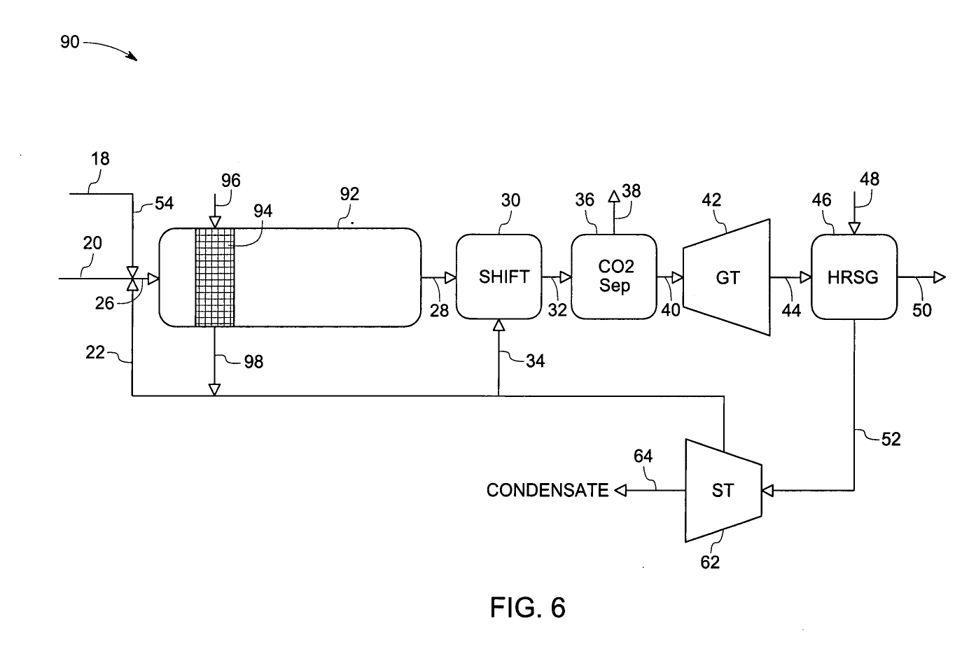

FIG. 6 illustrates an exemplary system 90, wherein the reformer 92 includes a cooling zone 94 within the mixed reforming zone 100. The purpose of the cooling zone 94 is to utilize the heat generated by the CPO reactions to generate steam. As shown in FIG. 6, a water stream 96 is introduced into the cooling zone 94, which cooling zone 94 is configured to generate steam 98 by utilizing the heat generated in the CPO reactions. The same concept of having a cooling zone inside the mixed reforming zone 100 may also be utilized in reforming for partial oxidation reaction in the absence of a catalyst. As shown in FIG. 6, the steam 98 generated from the cooling zone 94 is used to facilitate the reforming reactions in the reformer 92 or to enhance the reaction in the shift reactor 30 to enhance the conversion of carbon monoxide to carbon dioxide.

The systems for co-production of electricity and hydrogen described herein have many advantages. In the disclosed systems, the heat management in the reformer is efficiently achieved by layering the CPO and the steam reforming catalysts and also by introducing the oxidant through a plurality of injection points along the length of the reformer. The multiple point injection of the oxidant lowers the chances of hot spot formation in the reformer as the amount of oxygen available to a particular section of the reformer is limited and more controllable. This results in longer life of catalysts and the reformer may be scaled up to a higher capacity effectively. The separation of carbon dioxide from the hydrogen rich stream generated in the reformer in the pre-combustion stage before being sent to a turbine lowers the CO₂ emissions into the atmosphere. Integrating the exhaust heat recovery into the generation of steam and using that steam to generate electricity through a steam turbine increases the overall efficiency of the power generation systems described herein. Since the co-production systems described herein can generate substantially pure hydrogen, during off peak hours when the demand for electricity is low the system can still produce hydrogen to either store it for future use or sell it as a product.

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

What is claimed is:

1. A system for the co-production of hydrogen and electrical energy comprising:
a reformer comprising at least one mixed reforming zone configured to receive a fuel stream and steam, at least one steam reforming zone and a plurality of oxidant inlets to introduce an oxidant into said reformer, wherein said at least one mixed reforming zone is followed by said at least one steam reforming zone to produce a first reformate stream comprising hydrogen;
a shift reactor configured to receive said first reformate stream and generate a second reformate stream;
a carbon dioxide separation unit configured to receive said second reformate stream and separate carbon dioxide from said second reformate stream to generate a carbon dioxide rich stream and a hydrogen rich stream; and
a power generation device configured to receive said hydrogen rich stream to generate electrical energy.

2. The system of claim 1, wherein said power generation device is selected from the group consisting of a gas turbine, a fuel cell a reciprocating engine, and combinations thereof.

3. The system of claim 1, wherein said power generation device is a gas turbine configured to receive said hydrogen rich stream to generate said electrical energy and an expanded hot gas stream.

4. The system of claim 1, wherein said mixed reforming zone comprises a catalytic partial oxidation (CPO) or an auto-thermal reforming (ATR) zone.

5. The system of claim 1 further comprising a heat recovery system configured to receive said expanded hot gas and generate steam and a hot exhaust gas.

6. The system of claim 5 further comprising a steam turbine configured to receive a portion of said steam to generate electrical energy.

7. The system of claim 1, wherein said fuel is selected from the group consisting of natural gas, methane, methanol, ethanol, a stream comprising naphtha, butane, propane, diesel, kerosene, an aviation fuel, a coal derived fuel, a bio-fuel, an oxygenated hydrocarbon feedstock, and mixtures thereof.

8. The system in claim 1, wherein said fuel comprises natural gas.

9. The system of claim 1, wherein said steam reforming zone is configured to operate at about 500° C. to about 1200° C.

10. The system of claim 1, wherein said carbon dioxide separation unit is selected from the group consisting of at least one chemical absorber, pressure swing adsorber, cryogenic separator, membrane separator and carbon dioxide liquefier.

11. The system of claim 1, wherein said oxidant is selected from a group consisting of air, oxygen rich air, oxygen depleted air, and pure oxygen.

12. The system of claim 1, wherein said oxidant is air.

13. The system of claim 1, wherein a portion of said steam from said heat recovery system is introduced into said reformer.

14. The system of claim 1, wherein said hot exhaust gas is utilized to heat said oxidant or fuel.

15. A system for co-production of hydrogen and electrical energy comprising:
a reformer comprising at least one mixed reforming zone configured to receive a fuel stream and steam and a plurality of oxidant inlets to introduce an oxidant into said reformer to generate a first reformate stream comprising hydrogen;
a shift reactor configured to receive said first reformate stream and generate a second reformate stream;
a carbon dioxide separation unit configured to receive said second reformate and separate carbon dioxide from said second reformate to generate a carbon dioxide rich stream and a hydrogen rich stream;
a gas turbine configured to receive said hydrogen rich stream to generate power and an expanded hot gas stream;
a heat recovery system configured to receive said expanded hot gas stream and generate steam and a hot exhaust gas; and
a steam turbine configured to receive a portion of said steam to generate power.

16. The system of claim 15, wherein said mixed reforming zone comprises a catalytic partial oxidation (CPO) or an auto-thermal reforming (ATR) zone.

17. The system of claim 15, wherein said fuel is selected from the group consisting of natural gas, methane, methanol, ethanol, a stream comprising naphtha, butane, propane, diesel, kerosene, an aviation fuel, a coal derived fuel, a bio-fuel, an oxygenated hydrocarbon feedstock, and mixtures thereof.

18. The system in claim 15, wherein said fuel comprises natural gas.

19. The system of claim 15, wherein said steam reforming zone is configured to operate at about 500° C. to about 1200° C.

20. The system of claim 15, wherein said carbon dioxide separation unit is selected from the group consisting of at least one chemical absorber, pressure swing adsorber, cryogenic separator, membrane separator and carbon dioxide liquefier.

21. The system of claim 15, wherein said oxidant is selected from a group consisting of air, oxygen rich air, oxygen depleted air, and pure oxygen.

22. The system of claim 15, wherein said oxidant is air.

23. The system of claim 15, wherein said reformer further comprises a cooling zone configured to receive water and generate steam.

24. A method for co-production of electrical energy and hydrogen comprising:
reforming a fuel in a reformer comprising at least one mixed reforming zone configured to receive said fuel stream and steam, at least one steam reforming zone, and introducing an oxidant through a plurality of oxidant inlets into said reformer to produce a first reformate stream;
introducing said first reformate stream in a shift reactor and generating a second reformate stream comprising hydrogen and carbon dioxide;
separating carbon dioxide from said second reformate stream in a carbon dioxide separation unit and generating a carbon dioxide rich stream and a hydrogen rich stream;
introducing said hydrogen rich stream into a gas turbine and generating electrical energy and an expanded hot gas stream;
introducing said hot gas stream into a heat recovery system and generating steam; and
introducing a portion of said steam from said heat recovery system into a steam turbine and generating electrical energy.
